(19) United States
(12) Patent Application Publication
(10) Pub. No.: US 2018/0215287 A1
(43) Pub. Date: Aug. 2, 2018

(54) Adjusting device for adjusting a vehicle seat along a sliding axis

(71) Applicant: IMS Gear SE & Co. KGaA, Donaueschingen (DE)

(72) Inventors: Matthias Koop, Donaueschingen (DE); Wilfried Synovzik, Hüfingen (DE); Manuel Hengstler, St. Georgen (DE); Jens Fechler, Hüfingen (DE); Christian Geiges, Blumberg (DE)

(73) Assignee: IMS Gear SE & Co. KGaA, Donaueschingen (DE)

(21) Appl. No.: 15/886,555

(22) Filed: Feb. 1, 2018

(30) Foreign Application Priority Data
Feb. 1, 2017 (DE) 10 2017 101 996.0

(51) Int. Cl. B60N 2/06; B60N 2/02

(52) U.S. Cl. CPC B60N 2/067; B60N 2002/0236; B60N 2/0232

(57) ABSTRACT

An adjusting device for adjusting a vehicle seat along a sliding axis, having a first and a second lower rail, both of which are fixedly connected with the vehicle, a first upper rail, which is slidably supported in the first lower rail in parallel to the sliding axis and a second upper rail, which is slidably supported in the second lower rail in parallel to the sliding axis. The first lower rail and the first upper rail can enclose a first cavity and the second lower rail and the second upper rail enclose a second cavity. A first spindle can be arranged in the first cavity and non-rotatably connected to the first lower rail and a second spindle can be arranged in the second cavity and non-rotatably connected to the second lower rail.

### CROSS-REFERENCE TO RELATED APPLICATIONS

This application claims priority to German Patent Application No. 10 2017 101 996.0, filed Feb. 1, 2017, which is incorporated by reference in its entirety.

### BACKGROUND

The present application relates to an adjusting device for adjusting a vehicle seat along a sliding axis.

### SUMMARY

In the context of increasing the comfort inside vehicle, an increasing number of movements between two vehicle parts, which were manually performed in the past, are performed by motors, in particular electric motors. While in older vehicles, the window panes were manually lowered and lifted by rotating a crank, today almost without exception electric motorized window lifters are used. Electrically adjustable rear doors are increasingly used, through which the rear doors may be automatically opened and closed by pushing a button.

The seat adjustment is also increasingly performed by using electric adjusting motors. FIG. 1 shows, in a perspective view, an adjusting device, known in the art, for longitudinal seat adjustment of a vehicle seat along a sliding axis, wherein the sliding axis approximately coincides with the longitudinal axis of the vehicle. such an adjusting device is described in DE 10 2006 011 718 A1, for example.

This adjusting device has a first lower rail which is fixedly connected with the vehicle, and a second lower rail, which is fixedly connected with the vehicle, wherein FIG. 1 only shows the first lower rail. The lower rails may be fixed to the floor of the vehicle passenger compartment. The adjusting device also has a first upper rail, which is slidably supported in the first lower rail in parallel to the sliding axis, and a second upper rail, which is slidably supported in the second lower rail in parallel to the sliding axis, wherein only the first upper rail is also shown.

In the mounted state, the first lower rail and the first upper rail enclose a first cavity and the second lower rail and the second upper rail enclose a second cavity. In the first cavity a first spindle is positioned, which is connected, non rotatably, by using fixing elements, with the first lower rail. Correspondingly, in the second cavity a second spindle is positioned, which is connected, non rotatably, with the second lower rail.

The adjusting device also comprises a first gear, which interacts with the first spindle, being at least partially positioned within the first cavity and fixedly connected with the first upper rail, and a second gear, which interacts with the second spindle, being at least partially positioned within the second cavity and fixedly connected with the second upper rail.

A support, which extends between the first upper rail and the second upper rail, is secured to the first and second upper rail. The support carries a drive motor, which is usually an electric motor. A drive train extends between the electric motor and the first gear and between the electric motor and the second gear, wherein the drive train comprises a first drive shaft and a second drive shaft, which run essentially linearly.

FIG. 2 shows the adjusting device by means of a schematic plan view.

The gear of the example shown is a worm gear, which comprises a worm and a worm wheel, formed by a spindle nut, which mesh with each other. The worm gear is separately shown in FIG. 2B by means of a schematic representation. The spindle nut has an inner thread, not shown, in which the screw spindle is screwed. The drive shafts are fixedly connected with the worms.

The adjusting device operates in the following way: By actuating the drive motor, both drive shafts are set into rotation. The rotation of the drive shafts is transmitted to the worms, whereby the spindle nuts are in turn rotated. Due to this rotation, the spindle nuts move along the spindle. Since the gears are fixedly connected with the upper rails, they slide together with the upper rails along the sliding axis within the lower rails. The support, the drive train, the drive motor and the vehicle seat, which is not shown, follow this movement.

The length of the maximum adjusting stroke of the vehicle seat along the sliding axis essentially corresponds to the length of the spindles. The surface swept by the support and the drive train is approximately represented in FIG. 2a by a hatched portion. In order to ensure the sliding of the vehicle seat over the entire adjusting stroke, no obstacle should be present within the area shown between the two lower rails, against which the drive train, the support and/or the drive motor may collide.

As already noticed, for comfort reasons, electric motors are increasingly mounted on vehicles. The number of assisting and safety systems is also increasing, so that the space available within a vehicle, which is limited anyway, is steadily reduced. The problems related to a limited mounting space will further increase due to the progressive electrification of vehicles, since the batteries for storing electric energy have a relatively low energy density and thus require a lot of space.

The space on the indicated surface between the lower rails may be used for arranging flat components of any kind such as fire extinguisher, subwoofers, batteries or other electronic components, in particular for the following reason: since this space is at least substantially covered by the vehicle seat, this space cannot be used as feet space, so that the arrangement of flat objects would not disturb and these cannot be loaded or damaged by passengers. However, since this space has to remain free for above said reasons along the entire adjusting stroke for ensuring the adjustment of the vehicle seat, this space cannot be used for arranging components.

The object of the present disclosure is therefore to further develop an adjusting device for adjusting a vehicle seat along a sliding axis of above said type, in such a way that the space between the lower rails of the adjusting device may at least be partially used for arranging components.

This object is achieved by the features and structures recited herein. Advantageous embodiments of the present disclosure are also disclosed herein.

An embodiment of the present disclosure relates an adjusting device for adjusting a vehicle seat along a sliding axis, comprising a first lower rail, which is fixedly connected with the vehicle and a second lower rail, which is fixedly connected with the vehicle, a first upper rail, which is slidably supported in the first lower rail in parallel to the sliding axis and a second upper rail, which is slidably supported in the second lower rail in parallel to the sliding axis, wherein the first lower rail and the first upper rail enclose a first cavity and the second lower rail and the second upper rail enclose a second cavity.

This embodiment of the adjusting device also comprises a first spindle, which is positioned within the first cavity and is non-rotably connected with the first lower rail and a second spindle, which is positioned within the second cavity and is non-rotably connected with the second lower rail, a first gear, which interacts with the first spindle and is at least partially arranged in the first cavity and is fixedly connected to the first upper rail, and a second gear, which interacts with the second spindle and is at least partially arranged in the second cavity and is fixedly connected to the second upper rail, a drive motor positioned between the first upper rail and the second upper rail, and a drive train extending between the drive motor and the first gear and between the drive motor and the second gear, wherein the drive motor is positioned with an offset with respect to the first and to the second gear with reference to the sliding axis, and the drive train comprises distance spanning means for spanning the distance.

In the previously described adjusting device known from the state of the art the gears, the drive train and the drive motor are approximately positioned in a centered position on the upper rail. The use of the proposed distance bridging means in the drive train allows for the drive motor and drive train to be positioned by a selectable offset distance relative to the sliding axis, for example in the region of the anterior or posterior ends of the upper rails. When adjusting the vehicle seat in a direction, the drive motor and drive train are only partially displaced into the space between the lower rails, while when adjusting in the opposite direction they can be displaced out from the space between the lower rails. A portion of the space between the lower rails will not be swept by the drive train and drive motor due to the proposed embodiment of the adjusting device. In this portion of space components may be mounted, so that this space may be used.

According to a further embodiment, the distance bridging means comprise a first flexible drive shaft and a second flexible drive shaft. Flexible drive shafts, also called flex-shafts, allow for the distance between the drive motor and gears to be easily bridged without the need for additional constructive measures.

In an alternative embodiment, the first gear and the second gear may be respective worm gears. Worm gears allow for a higher transmission ratio within a relatively small space. Moreover, they are characterized by a low noise emission, which has positive effects over the perception of the seat adjustment by the vehicle occupants.

In an alternative embodiment, the worm gear may be provided with a worm having a worm axis and a worm wheel having a worm wheel axis, wherein the worm axis and the worm wheel axis form an angle of less than 90°. In the majority of worm gears, the worm axis and the worm wheel axis form an angle of 90°, although with a corresponding adaptation of the toothing of the worm wheel and of the worm, angles between the axes of less than 90° may be obtained. Such angles are in particular suitable in connection with flexible drive shafts, since in this way the angle difference, which the flexible drive shafts have to compensate, may be kept at a low level. The flexible drive shafts are thus bent less and therefore less stressed, whereby the lifetime is increased and the probability of failure may be lowered. The acoustic aspects are also improved.

An alternative embodiment is characterized in that the first gear and the second gear are respectively formed by a spur gear. Spur gears are characterized by a high efficiency, so that the adjusting device according to this embodiment may operate in a particularly efficient way.

A further embodiment is characterized in that the distance bridging means comprise a first belt gear and a second belt gear. Compared to spur gears, belt gears may be provided with a reduced noise emission.

In a further embodiment, the distance bridging means may comprise a first flexible drive shaft and a second flexible drive shaft. The first belt gear may be provided on the drive side with a first drive wheel connected to the first drive shaft and on the driven side with a first driven wheel, which is a first spindle nut interacting with the first spindle. Moreover, the second belt gear may be provided on the drive side with a second drive wheel connected with the second drive shaft and on the driven side with a second driven wheel, which is a second spindle nut interacting with the second spindle.

When using belt gears, the choice of the position for the drive wheel is flexible, since this position many be easily modified by a corresponding adjustment of the length of the belt, which is not so easily accomplished in the case of spur gears. This embodiment may thus be adapted to different constructive geometries of existing adjusting devices. In particular, the connection of the drive wheel to the flexible drive shaft may be simplified compared to spur gears.

According to a further embodiment, the drive train, the first and second gear and the first and second spindle are configured in such a way that between the torque provided by the drive motor and the torque applied on the spindles a total transmission ratio between 6 and 7 is provided, the first and second spindle has a thread pitch which is reduced or increased with respect to a normal thread pitch and the drive train and/or the first and second gear are adapted to the reduced or increased thread pitch so that the total transmission ratio is maintained. In adjusting devices known in the state of the art, which correspond to those described in DE 10 2006 011 718 A1, the normal thread pitch lies between 2.5 and 3.5 mm. Compared to this normal thread pitch, the thread pitch is reduced by 60 to 70%, for example. In order to still have the same total transmission ratio, the drive train and/or the gears are correspondingly adapted. If the drive train is left unchanged, then the gears have to reduce to a lesser extent the rotational speed transmitted by the drive motor, so that the transmission ratio of gear is nearer to 1 compared to known adjusting devices. This measure may be selectively introduced in particular in spur gears, since in spur gears or intermediate gears the distance between the axes of both spur gears is defined by their diameter. However, according to the constructive preconditions, the distance has to have a determined minimum value, for example, in order to connect the flexible drive shaft to the spur gears. The modified thread pitch may be correspondingly modified, in order to adapt the diameters of both spur gears and thus to increase or reduce the distance between the axes.

According to a further embodiment, the drive train, the first and second gear and the first and second spindle are provided in such a way that between the torque provided by the drive motor and the torque applied to the spindles a total transmission ratio between 6 and 7 is applied, the drive train comprises a further gear, in particular a motorized worm gear, and the first and second spindle and/or the first and second gear are adapted to the further gear in such a way that the total transmission ratio is maintained.

The additional gear and in particular the motorized worm gear, which represents a transfer case, is used for reducing the speeds of the flexible drive shafts and in the gears connected thereto, whereby the heat generation is reduced and thus the wear caused thereby. A reduced rotational speed also positively influences the noise emission in the gears connected to the drive shafts.

In a further embodiment, the drive train comprises a first drive shaft and a second drive shaft, wherein the first gear is configured as a first worm gear and the second gear is configured as a second worm gear, the first belt gear comprises on the drive side a first drive wheel connected to the first drive shaft and on the driven side a first driven wheel interacting with the first worm gear and the second belt gear comprises on the drive side a second drive wheel connected to the second drive shaft and on the drive side a second driven wheel interacting with the second worm gear. In this embodiment, linear drive shafts and worm gears may be used, which is also the case in known adjusting devices. The worm gears already used for known adjusting devices may be used without any constructive modification. Insofar the constructive adaptation is essentially limited only to the provision of the belt gears, so that the additional effort with respect to known adjusting devices is low.

An embodiment of the present disclosure refers to an adjusting device for adjusting a vehicle seat along a sliding axis, comprising a first lower rail, which is fixedly connected with the vehicle and a second lower rail, which is fixedly connected with the vehicle, a first upper rail, which is slidably supported in the first lower rail in parallel to the sliding axis and a second upper rail, which is slidably supported in the second lower rail in parallel to the sliding axis, wherein the first lower rail and the first upper rail enclose a first cavity and the second lower rail and the second upper rail enclose a second cavity.

This embodiment of the adjusting device also comprises a first spindle which is positioned within the first cavity and is rotatably supported around a first rotation axis and a second spindle which is positioned within the second cavity and is rotatably supported around a second rotation axis, a first spindle nut, which interacts with the first spindle and is at least partially arranged within the first cavity and is fixedly connected to the first upper rail and a second spindle nut, which interacts with the second spindle and is at least partially arranged within the second cavity and is fixedly connected to the second upper rail.

Moreover, this embodiment of the adjusting device also has a first drive motor, which is operatively connected with the first spindle on the drive side for driving the first spindle, and a second drive motor, which is operatively connected with the second spindle on the driven side for driving the second spindle.

Contrary to previously mentioned embodiments, the spindles in this case are rotatably supported within the cavity between the upper rails and the lower rails. Each spindle has its own drive motor associated thereto, in order to rotate the spindle. The respective drive motor may be positioned very near to the corresponding spindle, so that the space required therefor is small. In particular no drive motor is arranged between the upper rails and no drive train is provided, which extends through the space between the upper rails. The space between the lower rails is entirely usable.

According to a further embodiment, the first drive motor may comprise a first driven shaft and the second drive motor may comprise a second driven shaft and the first driven shaft may be aligned to the first rotation axis and the second driven shaft may be aligned to the second rotation axis. The driven shafts may be rigid, and thus of simpler construction with respect to flexible shafts, which reduces the production costs. Moreover, the space occupied by both drive motors between the two lower rails is small, so that this space is entirely or almost entirely usable.

According to an alternative embodiment, the adjusting device comprises a first gear, which is connected, on the drive side, with the first drive motor for driving the first spindle and which is operatively connected, on the driven side, with the first spindle, a second gear, which is connected, on the drive side, with the second drive motor for driving the second spindle and which is operatively connected, on the driven side, with the second spindle. The use of gears allows for the provision of torques required for adjusting the vehicle seat without the need for the drive motor to be of corresponding large size, so that in particular construction space may be saved. The drive motors used for adjusting the vehicle seat are almost all electric motors having a relatively high rotational speed output. The vehicle seat, however, has to be preferably adjusted at low speeds, and this can be accomplished by using gears, in a simple and space saving way.

In a further elaboration, the first gear may be a first planetary gear and the second gear a second planetary gear. Planetary gears provide a high transmission ratio within a reduced construction space. Moreover, both the planetary gear and the drive motor may be arranged on the same axis of the spindle, so that space may be saved.

In a still further embodiment of the adjusting device, the first planetary gear and/or the second planetary gear may be a helical planetary gear. Helical planetary gears provide a still higher transmission ratio compared to conventional planetary gears, at the same boundary conditions. The engagement within a helical planetary gear is also very uniform, and the noise emission is lower compared to conventional planetary gears.

### BRIEF DESCRIPTION OF DRAWINGS

Exemplary embodiments of the present disclosure are explained in the following with reference to the annexed drawings. In particular:

FIG. 1 shows a perspective illustration of an adjusting device known in the art,

FIG. 2A shows a schematic plan view of an adjusting device known in the art,

FIG. 2B shows a separate schematic view of a worm gear, which is used in the adjusting device of FIG. 2A,

FIG. 3 shows a first example of a proposed adjusting device based on a schematic plan view,

FIG. 4 shows a second example of a proposed adjusting device based on a schematic plan view,

FIG. 5A shows a partially cut-out view through a helical planetary gear,

FIG. 5B shows a perspective view of the helical planetary gear of FIG. 5A,

FIG. 6A shows a third example of a proposed adjusting device based on a schematic plan view,

FIG. 6B shows the first worm gear shown in FIG. 6A based on a schematic separate illustration,

FIG. 7 shows a fourth example of a proposed adjusting device based on a schematic plan view,

FIG. 8 shows a fifth example of a proposed adjusting device based on a schematic plan view,

FIG. 9 shows a sixth example of a proposed adjusting device based on a schematic plan view, and

FIG. 10 shows a seventh example of a proposed adjusting device based on a schematic plan view.

### DETAILED DESCRIPTION

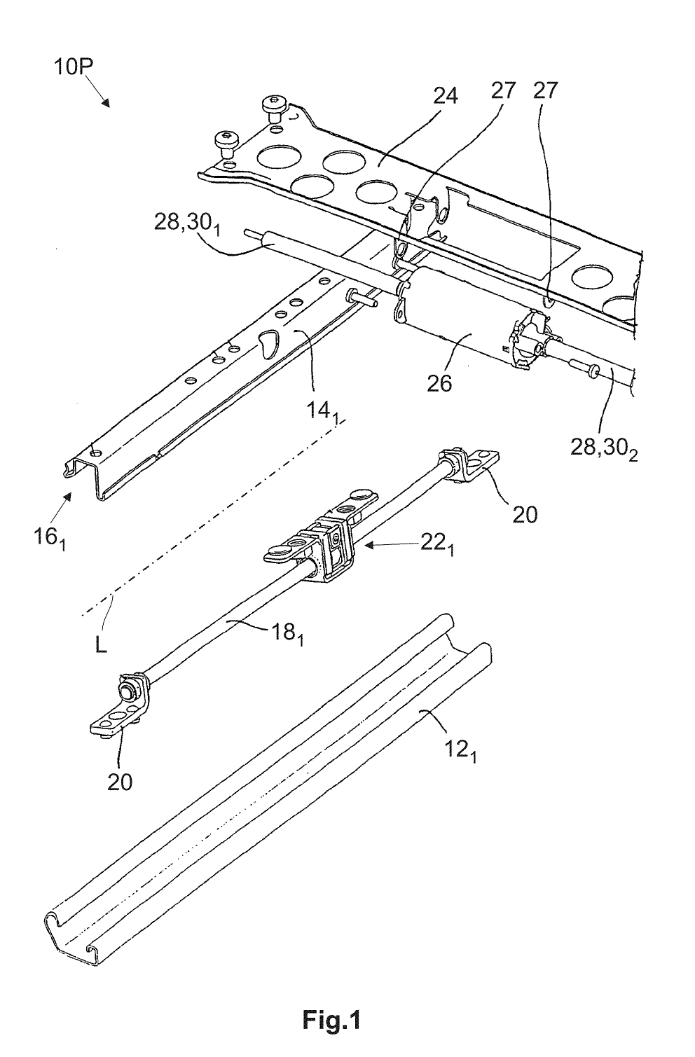

In FIG. 1 a known adjusting device 10P for longitudinal seat adjustment of a vehicle seat, not shown, is illustrated, in perspective, along a sliding axis L, wherein the sliding axis L approximately coincides with the longitudinal axis of the vehicle, which is also not shown.

The adjusting device 10P has a first lower rail 12₁ fixedly connected with the vehicle, and a second lower rail 12₂ fixedly connected with the vehicle, wherein in FIG. 1 only the first lower rail 12₁ is shown. The lower rails 12₁, 12₂ may be fixed to the floor of the vehicle passenger compartment. The adjusting device 10P also has a first upper rail 14₁ which is slidably supported within the first lower rail 12₁ in parallel to the sliding axis L and a second upper rail 14₂ which is slidably supported within the second lower rail 12₂ in parallel to the sliding axis L, wherein also in this case only the first upper rail 14₁ is shown. The upper rails 14₁, 14₂ slide directly or via adjusting and/or supporting elements, not shown, on the lower rails 12₁, 12₂. A vehicle seat, not shown, is secured to both upper rails 14₁, 14₂.

In the mounted state, the first lower rail 12₁ and the first upper rail 14₁ enclose a first cavity 16₁ and the second lower rail 12₂ and the second upper rail 14₂ enclose a second cavity 16₂. In the first cavity 16₁ a first spindle 18₁ is positioned, which is non-rotatably connected to the first lower rail 12₁ by means of fixing elements 20. Correspondingly, in the second cavity 16₂ a second spindle 18₂ is positioned, which is non-rotatably connected with the second lower rail 12₂ (not shown).

The adjusting device 10P also has a first gear 22₁, interacting with the first spindle 18₁ and positioned, at least partially, within the first cavity 16₁ and which is fixedly connected with the first upper rail 14₁ and a second gear 22₂, interacting with the second spindle 18₂ and positioned, at least partially, within the second cavity 16₂ and which is fixedly connected with the first upper rail 14₁.

A support 24 extends between the first upper rail 14₁ and the second upper rail 14₂, wherein the support is secured to the first and second upper rail 14₁, 14₂. On the support 24, a drive motor 26 having securing brackets 27 is secured, which is usually an electric motor. The provision of the support 24 is not strictly necessary. The support 24 may be omitted by securing the drive motor 26 to the vehicle seat. Between the drive motor 26 and the first gear 22₁ and between the drive motor 26 and the second gear 22₂ a drive train 28 extends, which comprises a linear first drive shaft 30₁ and a linear second drive shaft 30₂.

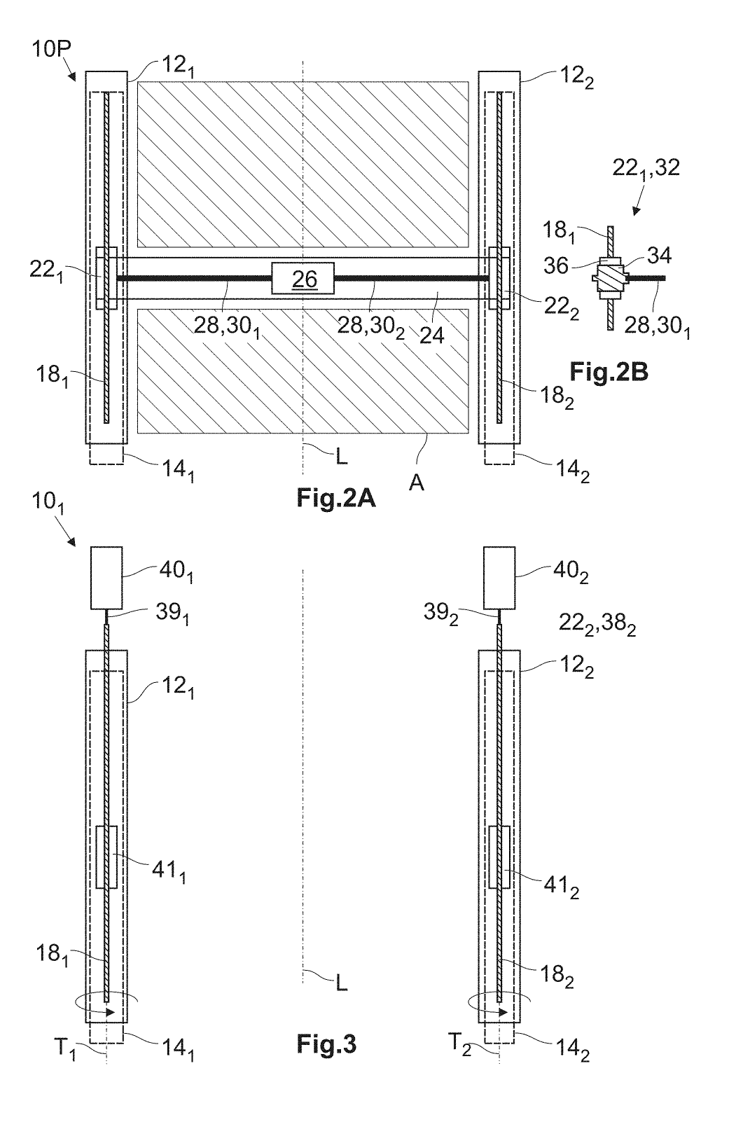

FIG. 2A shows the adjusting device 10 based on a schematic plan view.

The gears 22₁, 22₂ in the example shown are formed by a respective worm gear 32, which comprises a worm 34 and a worm wheel 36, which is a spindle nut 41, which mesh with each other. The worm gear 32 is separately shown by means of a schematic representation in FIG. 2B. The spindle nut 41 has an inner thread, not shown, in which the spindle 18₁ is screwed. The drive shafts 30 are non-rotatably connected with the worms 34.

The adjusting device 10P operates in the following way: by actuating the drive motor 26, both drive shafts 30₁, 30₂ are set in rotation. The rotation of the drive shafts 30₁, 30₂ is transmitted to the worms 34, whereby in turn the spindle nuts 41 are rotated. Due to this rotation, the spindle nuts 41 move along the spindles 18₁, 18₂. Since gears 22₁, 22₂ are fixedly connected with upper rails 14₁, 14₂, they move together with the upper rails 14₁, 14₂ along the sliding axis L within the lower rails 12₁, 12₂. The support 24, the drive train 28, the drive motor 26 and the vehicle seat, not shown, follow this movement.

The length of the maximum adjustment stroke of the vehicle seat along the sliding axis L is essentially equal to the length of spindles 18₁, 18₂. The surface A swept by the support 24 and drive train 28 is approximately indicated by a hatched portion in FIG. 2A. In order to ensure the sliding of the vehicle seat over the entire adjustment stroke, in the area A between the two lower rails 12₁, 12₂ no obstacle should be present, against which the drive train 28 and/or the drive motor 26 may collide.

FIG. 3 shows a first example of an inventive adjusting device 10₁ based on a schematic plan view. The structure of the inventive adjusting device 10₁ according to the first exemplary embodiment differs from the structure of known adjusting device 10P in particular in following aspects:

The first and second spindle 18₁, 18₂ in this case are rotatably supported around a rotation axis T and are directly connected, at one end, with a respective driven shaft 39 of a drive motor 40₁, 40₂. Thus, a first drive motor 40₁ is associated to the first spindle 18₁ and a second drive motor 26 is associated to the second spindle 40₂. The first drive motor 40₁ or its driven shaft 39 is aligned with the rotation axis T of the first spindle 18₁ and the second drive motor 40₂ or its driven shaft 39 is aligned with the rotation axis T of the second spindle 18₂. The adjusting device 10 in this example also comprises a first spindle nut 41₁ and a second spindle nut 41₂, which are fixedly connected with the first and second upper rail 14₁, 14₂, respectively, and which interact with the first spindle 18₁ and second spindle 18₂, respectively. A support 24 is not required.

In this embodiment of the proposed adjusting device 10₁, between both lower rails 12₁, 12₂ no component of the adjusting device 10₁ is disposed, so that the space between both lower rails 12₁, 12₂ may be completely used for arranging vehicle components of any kind such as storage compartments, fire extinguishers, subwoofers, batteries, and/or other electronic components.

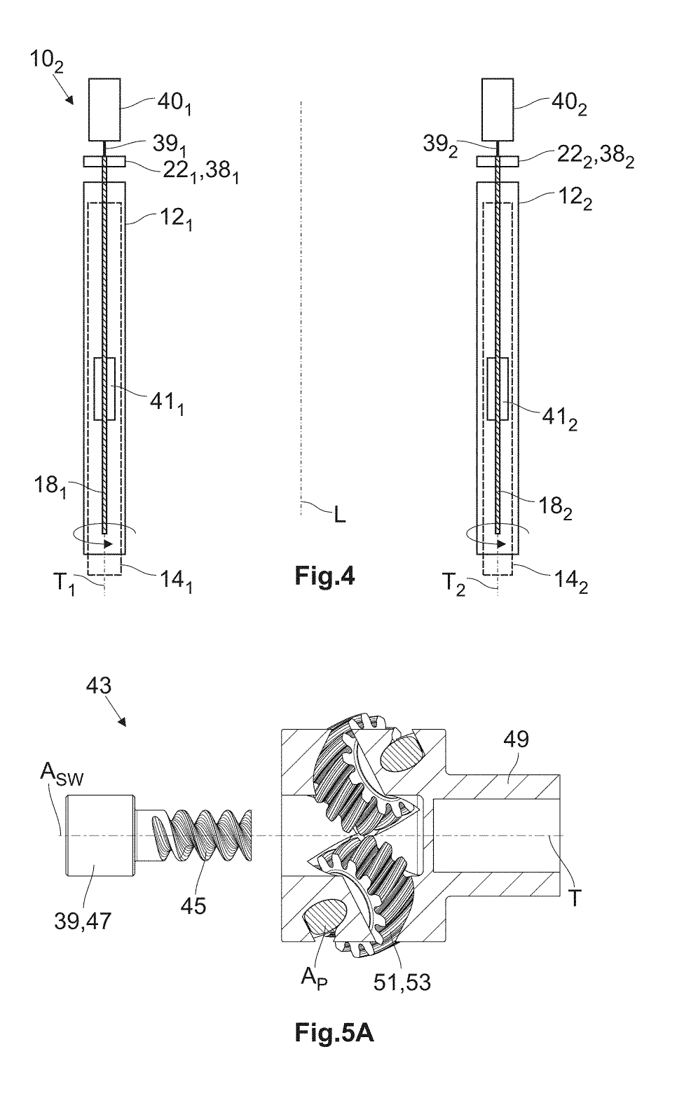

The second exemplary embodiment shown in FIG. 4 of the adjusting device 10₂ is predominantly identical to the first example of the adjusting device 10₁ shown in FIG. 3. Herein, again, the first and second spindle 18₁, 18₂ are rotatably supported, although the first and second spindle 18₁, 18₂ are not directly connected with the driven shaft 39 of the first and second drive motors 40₁, 40₂. Instead, the first spindle 18₁ is connected, at one end, with the first gear 22₁ and the second spindle 18₂ is connected with one end to the second gear 22₂. In the second example the first gear 22₁ and second gear 22₂ are respective planetary gears 38₁, 38₂. Each planetary gear 38₁, 38₂ is connected, on the drive side, to the driven shaft 39 of the first and second drive motor 40₁, 40₂, respectively. Thus, a first drive motor 40₁ is associated to the first spindle 18₁ and a second drive motor 26 is associated to the second spindle 40₂. The first drive motor 40₁ or its driven shaft 39 and the first planetary gear 38₁ are aligned with the rotation axis T of the first spindle 18₁ and the second drive motor 40₂ or its driven shaft 39 and the second planetary gear 38₂ are aligned with the rotation axis T of the second spindle 18₂.

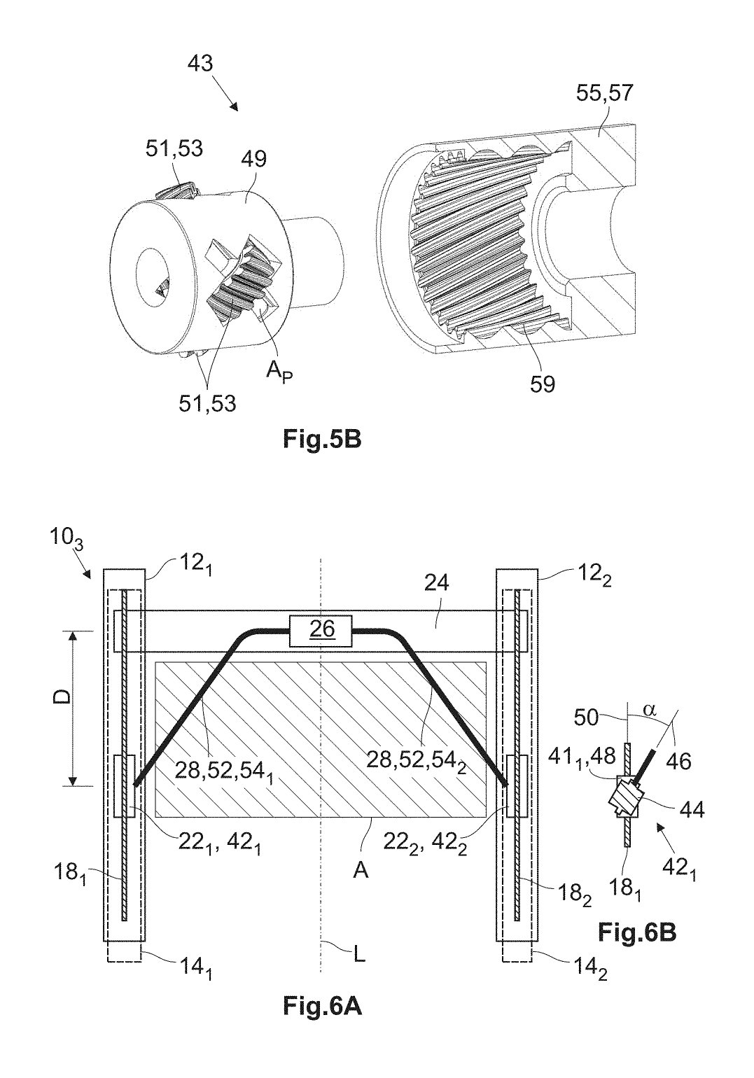

The first planetary gear 381 and the second planetary gear 382 may be conventional planetary gears or so called helical planetary gears 43. Such a helical planetary gear 43 is shown in FIGS. 5A and 5B, in parts and in an unmounted state, respectively. In this case, the driven shaft 39 has a helical gear 45, whereby the driven shaft 39 is also called a helical shaft 47, which may rotate around a helical shaft axis A_{SW}. As in conventional planetary gears, a satellite carrier 49 is present, in which, in this case, three satellite wheels 51 (see in particular FIG. 5B) are rotatably supported about respective satellite wheel axis AP. The satellite wheels 51 have a satellite wheel toothing 53, which is adapted to the helical toothing 45, so that an essentially optimal meshing between the helical shaft 47 and the satellite wheels 51 is provided. A special characteristic of the helical planetary gear 43 is that the satellite axis AP are skewed with respect to the helical shaft axis Asw.

As shown in FIG. 5B, the helical planetary gear 43 also has a crown wheel 53, which in this case is provided as an inner screw gear 55 with an inner toothing 59, wherein the inner toothing 59 is adapted to the planetary toothing 53 in such a way that an essentially optimal meshing between the satellite wheels 51 and the crown wheel 47 is provided. The satellite carrier 49 is rotatably supported within the inner screw gear 55. As in conventional planetary gears, in case of a rotating helical shaft 47, either the satellite carrier 49 or the inner screw gear 47 may be stationary and the respective other part may rotate. In this example, the inner screw gear 47 may be non-rotatably connected to a housing, not shown, of the drive motor 40 and the spindle may be non-rotatably connected to the satellite carrier 49. Thus, the helical shaft axis A_{SW} and the rotation axis T coincide.

In FIG. 6A, a third example of the proposed adjusting device 103 is shown, which is also shown in a schematic plan view. In this example, the adjusting device 10₂ has the support 24 extending between the first and second upper rail 14₁, 14₂, on which the drive motor 26 is disposed.

The first gear 22₁ is a first worm gear 42₁ and the second gear 22₂ is a second worm gear 42₂. The first worm gear 42₁ is separately shown in FIG. 6B. The worm gears 42₁, 42₂ comprise a respective worm 44 having a worm axis 46 and a worm wheel 48 having a worm wheel axis 50, which form an angle α between them. In this case, the angle α is less than 90°, approximately equal to 30°.

The worm gears 42₁, 42₂ are offset, relative to the sliding axis L, by a distance D to the drive motor 26. The drive train 28 comprises a distance bridging means 52, which is formed by a flexible first drive shaft 54₁ and a flexible second drive shaft 54₂.

Again, as in FIG. 2A, an area A is approximately shown, which is the maximum surface swept by the support 24, the drive train 28 and the drive motor 26 during the adjustment of the vehicle seat between the lower rails 12₁, 12₂. It may be noticed that a portion of space between the lower rails 12₁, 12₂ is not being swept and thus may be used for arranging components.

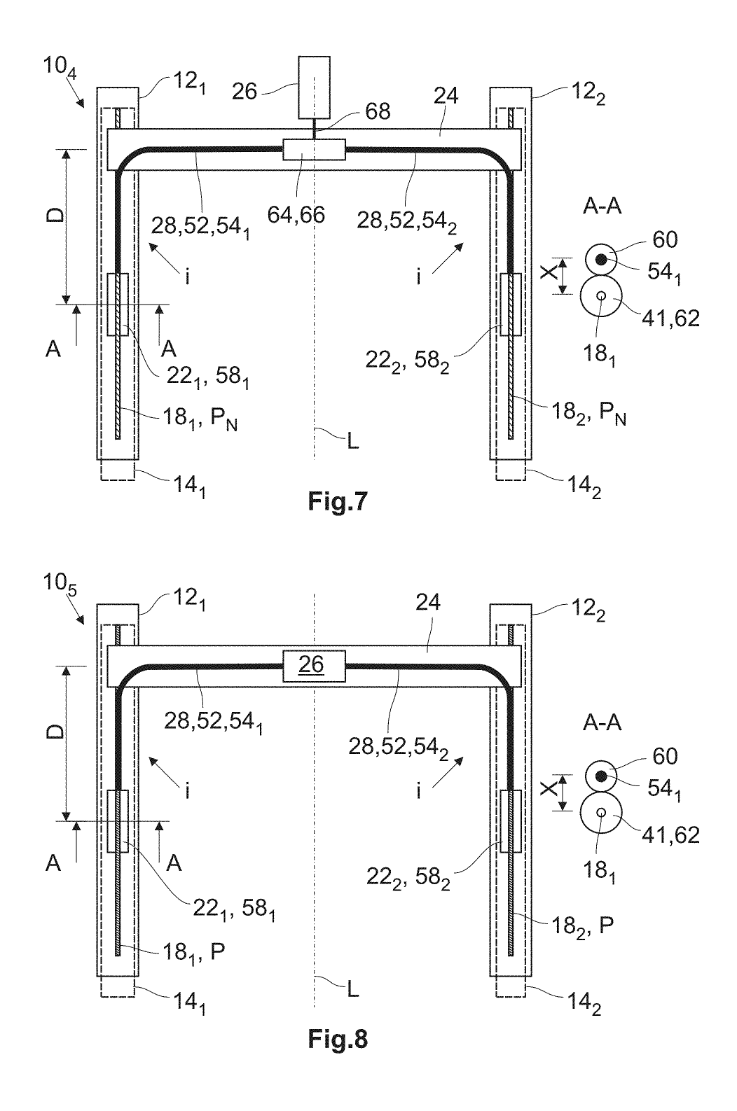

FIG. 7 shows a fourth example of the inventive adjusting device 10₄, also by means of a schematic plan view. In this case, the first gear 22₁ is provided as a first spur gear 58₁ and the second gear 22₂ is provided as a second spur gear 58₂ which is offset with respect to the drive motor 26 the distance D along the sliding axis L. The drive train 28 also comprises the flexible drive shafts 54₁, 54₂, which are non-rotatably connected, at one end, to an upper spur wheel 60. The upper spur wheel 60 meshes with a rotatable lower spur wheel 62, which is formed by the spindle nut 41, and which interacts with the spindle 18₁.

The flexible drive shafts 54₁, 54₂ are connected, by the other end, to a further gear 64, in this case, to a motorized worm gear 66, which is connected, on the drive side, to a driven shaft 68 of the drive motor 26. A direct connection to the drive motor 26 may also be conceived. The further gear 64 is used as a case gear. The drive train 28, the spur gear 58 and the spindle 18 provide a total transmission ratio i. To this end, the spindles 18₁, 18₂ have a normal thread pitch PN, between 2.5 and 3.5 mm, as in known adjusting devices 10P.

Due to the arrangement of the upper spur wheel 60 and lower spur wheel 62, the flexible drive shafts 54₁, 54₂ extend above the upper rails 14₁, 14₂, and do not pass through the space between both lower rails 12₁, 12₂, thus making it more usable for arranging components. This however presupposes that the axis distance X between the upper spur wheel 60 and the lower spur wheel 62 is correctly selected. In particular, the axis distance X should be big enough for the upper spur wheel 60 to sufficiently protrude from the cavity 16, in order to connect the flexible drive shaft 54 to the upper spur wheel 60. The axis distance X in spur gears 58 is determined by diameters of the upper spur wheel 60 and lower spur wheel 62. The diameter of the lower spur wheel 62 cannot be arbitrary, since otherwise it would collide with the upper rail 12 or lower rail 14. The further gear 64 already reduces the speed of the flexible drive shafts 54₁, 54₁ to a certain extent, so that the spur gear 58 is required to provide a small or no transmission ratio at all. The lower the transmission ratios, the closer get the diameters of the upper and lower spur wheel 60, 62, whereby the axis distance X may be adapted to the constructive needs. The noise emission in spur gears at low speeds may also be kept at a low level.

In FIG. 8 a fifth exemplary embodiment of the inventive adjusting device 10₅ is shown, again in a schematic plan view. The structure of the fifth example is essentially identical to the structure of the fourth example, wherein, however, the drive train 28 is lacking the further gear 64. The spindles 18₁, 18₂ have a thread pitch P which is about 60 to 70% smaller than the normal thread pitch P of the fourth example, for example. Due to the reduced thread pitch P, the spur gears 58₁, 58₂ have a low transmission ratio about 1. As already indicated with reference to the fourth example, the axis distance X may thus be adapted to constructive requirements, without modifying the total transmission ratio i.

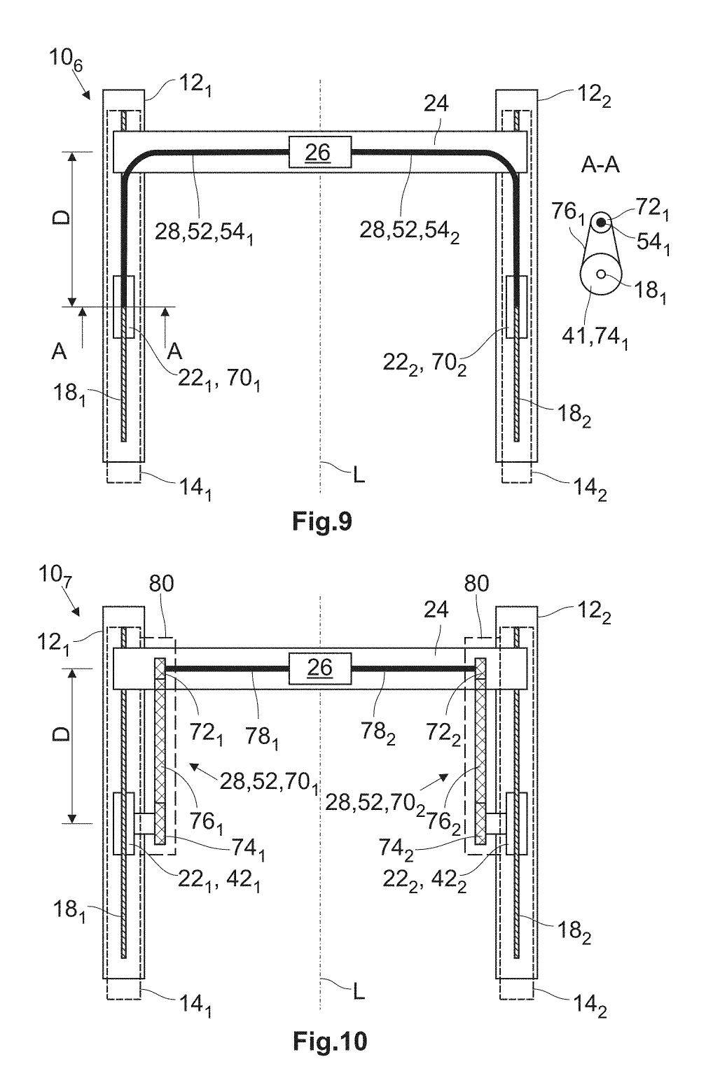

In FIG. 9 a sixth exemplary embodiment of the inventive adjusting device 10₆ is shown, again in a schematic plan view. In this case, the drive train 28 comprises a first belt gear 70₁ and a second belt gear 70₂, which are offset to the drive motor 26 by a distance D along the sliding axis L. The first belt gear 70₁ has, on the drive side, a first drive wheel 72₁, which is rotatably connected to the flexible first drive shaft 54₁. The first belt gear 70₁ also comprises, on the driven side, a first driven wheel 74₁, which is provided as the spindle nut 41, and which interacts with the first spindle 18₁. A first belt 76₁ is disposed between the first drive wheel 72₁ and the first driven wheel 74₁. The second belt gear 70₂ is constructed correspondingly. The drive shafts 54₁, 54₂ extend above the upper rails 14₁, 14₂.

FIG. 10 shows a seventh example of the inventive adjusting device 10₇, again in a schematic plan view. In this case also the drive train 28 comprises the first and second belt gear 70₁, 70₂, which, however, are arranged in a slightly different way. The drive train 28 comprises two drive shafts 78₁, 78₂, which may be of the rigid type and extend linearly along the support 24. The first gear 22₁ and the second gear 22₂ are configured as worm gears 42₁, 42₂ having an axis angle α of 90° and are offset by a distance D along the sliding axis L to the drive motor 26. The belt gears 70₁, 70₂ are disposed between the drive shafts 78₁, 78₂ and the worm gears 42₁, 42₂. The first belt gear 70₁ comprises, on the drive side, the first drive wheel 72₁ which is non-rotatably connected to the drive shaft 78₁ and on the drive side the first driven wheel 74₁, which is interacting with the worm gear 42₁. The first belt 76₁ between the first drive wheel 72₁ and the first driven wheel 74₁ is parallel to the upper rail 14₁, whereby the distance D is bridged. The first belt gear 70₁ is disposed in a housing 80. The construction of the second belt gear 70₂ is analogous to the one of the first belt gear 70₁.

### REFERENCE LIST

10, 10₁-107 adjusting device
10P known adjusting device
12, 12₁, 12₂ lower rail
14, 14₁, 14₂ upper rail
16, 16₁, 16₂ cavity
18, 18₁, 18₂ spindle
20 mount
22, 22₁, 22₂ gear
24 support
26 drive motor
27 securing bracket
28 drive train
30, 30₁, 30₂ drive shaft
32 worm gear
34 worm
36 worm wheel, spindle nut
38, 38₁, 38₂ planetary gear
39, 39₁, 39₂ driven shaft
40, 40₁, 40₂ drive motor
41, 41₁, 41₂ spindle nut
42, 42₁, 42₂ worm gear
43 helical planetary gear
44 worm
45 helical toothing
46 worm axis
47 worm wheel axis
48 worm wheel
49 satellite carrier
50 worm wheel axis
51 satellite wheel
52 distance bridging means
53 satellite wheel toothing
54, 54₁, 54₂ flexible drive shaft
55 crown gear
56, 56₁, 56₂ bevel gear
57 inner thread gear
58, 58₁,58₂ spur gear
59 inner toothing
60 upper spur wheel
62 lower spur wheel
64 further gear
66 motorized worm gear
68 driven shaft
70, 70₁,70₂ belt gear
72, 72₁, 72₂ drive wheel
74, 74₁, 74₂ driven wheel
76, 76₁, 76₂ belt
78, 78₁, 78₂ linear drive shaft
80 housing
A surface
A_{P} satellite wheel axis
A_{SW} helical shaft axis
D distance
i transmission ratio
L sliding axis
P thread pitch
P_{N} thread normal pitch
T, T₁, T₂ axis of rotation
X axis distance
α axis angle

1. An adjusting device for adjusting a vehicle seat along a sliding axis, comprising:
a first lower rail, which is fixedly connected with a vehicle and a second lower rail, which is fixedly connected with the vehicle,
a first upper rail, which is slidably supported in the first lower rail in parallel to a sliding axis and a second upper rail, which is slidably supported in the second lower rail in parallel to the sliding axis, wherein the first lower rail and the first upper rail enclose a first cavity and the second lower rail and the second upper rail enclose a second cavity,
a first spindle arranged in the first cavity and rotatably supported around a first rotation axis and a second spindle arranged in the second cavity and rotatably supported around a second rotation axis,
a first spindle nut interacting with the first spindle and at least partially arranged within the first cavity and fixedly connected with the first upper rail and a second spindle nut, interacting with the second spindle and at least partially arranged within the second cavity and fixedly connected with the second upper rail;
a first drive motor, which is operatively connected, on a driven side, with the first spindle for driving the first spindle; and
a second drive motor, which is operatively connected, on the driven side, with the second spindle, for driving the second spindle.

2. The adjusting device of claim 1, wherein the first drive motor comprises a first driven shaft and the second drive motor comprises a second driven shaft; and
wherein the first driven shaft is aligned with the first rotation axis and the second driven shaft is aligned with second rotation axis.

3. The adjusting device of claim 1, wherein the adjusting device comprises:
a first gear, which is operatively connected, on a drive side, to the first drive motor for driving the first spindle and which is operatively connected, on the driven side, to the first spindle, and
a second gear, which is operatively connected, on the drive side, to the second drive motor for driving the second spindle and which is operatively connected, on the driven side, to the second spindle.

4. The adjusting device of claim 3, wherein the first gear is formed as a first planetary gear and the second gear is formed as a second planetary gear.

5. The adjusting device of claim 4, wherein the first planetary gear, the second planetary gear, or both, are formed as a helical planetary gear.

6. An adjusting device for adjusting a vehicle seat along a sliding axis, comprising:
a first lower rail, which is fixedly connected with the vehicle and a second lower rail, which is fixedly connected with the vehicle,
a first upper rail, which is slidably supported in the first lower rail in parallel to the sliding axis and a second upper rail, which is slidably supported in the second lower rail in parallel to the sliding axis, wherein the first lower rail and the first upper rail enclose a first cavity and the second lower rail and the second upper rail enclose a second cavity,
a first spindle arranged in the first cavity and non-rotatably connected to the first lower rail and a second spindle arranged in the second cavity and non-rotatably connected to the second lower rail,
a first gear interacting with the first spindle and at least partially arranged in the first cavity and which is fixedly connected with the first upper rail and a second gear interacting with the second spindle and at least partially arranged within the second cavity and which is fixedly connected with the second upper rail,
a drive motor arranged between the first upper rail and the second upper rail,
a drive train extending between the drive motor and the first gear and between the drive motor and the second gear,
wherein the drive motor is offset, by a distance relative to the sliding axis to the first gear and to the second gear and the drive train comprises connecting element for bridging the distance.

7. The adjusting device of claim 6, wherein the connecting element comprises a flexible first drive shaft and a flexible second drive shaft.

8. The adjusting device of claim 6, wherein the first gear and the second gear are formed by a respective worm gear.

9. The adjusting device of claim 8, wherein the worm gear comprises a worm with a worm axis and a worm wheel having a worm wheel axis, wherein the worm axis and the worm wheel axis form an axis angle which is less than 90 degrees.

10. The adjusting device of claim 9, wherein the first gear and the second gear are formed as a respective spur gear.

11. The adjusting device of claim 6, wherein the connecting element comprises a first belt gear and a second belt gear.

12. The adjusting device of claim 6, wherein the connecting element comprises a flexible first drive shaft and a flexible second drive shaft,
wherein the first belt gear has, on the drive side, a first drive wheel which is connected to the first drive shaft and on a driven side, a first driven wheel, which is configured as a first spindle nut interacting with the first spindle, and
the second belt gear has, on the drive side, a second drive wheel which is connected to the second drive shaft and on the driven side, a second driven wheel, which is configured as a second spindle nut interacting with the second spindle.

13. The adjusting device of claim 11, wherein the drive train comprises a first drive shaft and a second drive shaft,
wherein the first gear is configured as a first worm gear and the second gear is configured as a second worm gear,
wherein the first belt gear comprises, on the drive side, a first drive wheel connected to the first drive shaft and on the driven side, a first driven wheel interacting with the first worm gear and
wherein the second belt gear comprises, on the drive side, a second drive wheel connected to the second drive shaft and, on the driven side, a second driven wheel interacting with the second worm gear.

14. The adjusting device of claim 6, wherein the drive train, the first and the second gear and the first and the second spindle are provided in such a way that between torque provided by the drive motor and torque applied to spindles, a total transmission ratio from 6 to 7 is applied,
wherein the first and the second spindle have a thread pitch, which is reduced or increased with respect to a normal thread pitch and
wherein the drive train, the first and the second gear, or both, are adapted to a reduced or increased thread pitch in such a way that the total transmission ratio is preserved.

15. The adjusting device of claim 6, wherein the drive train, the first and the second gear and the first and the second spindle are provided in such a way that between torque provided by the drive motor and torque applied to spindles a total transmission ratio from 6 to 7 is applied,
wherein the drive train comprises a further motorized worm gear, and
the first and the second spindle, the first and the second gear, or both are adapted to the further gear in such a way that the total transmission ratio is preserved.
